(19) United States
(12) Patent Application Publication
(10) Pub. No.: US 2007/0185857 A1
(43) Pub. Date: Aug. 9, 2007

(54) System and method for extracting salient keywords for videos

(75) Inventors: Martin G. Kienzle, Briarcliff Manor, NY (US); Ying Li, Mohegan Lake, NY (US); Youngja Park, Edgewater, NJ (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/337,371

(22) Filed: Jan. 23, 2006

(51) Int. Cl. G06F 17/30

(52) U.S. Cl. 707/5

(57) ABSTRACT

Computer implemented method, system and computer program product for extracting salient keywords for videos. A computer implemented method for extracting salient keywords for videos includes extracting a set of candidate keywords from a text source of a video, assigning a salience value to each candidate keyword based on statistical information to provide a set of statistically significant keywords, exploiting additional cues that are available to the video and that can be used to further measure the significance of existing keywords or to extract new keywords, and selecting a set of salient keywords for the video based on the set of statistically significant keywords and the additional cues.

### BACKGROUND OF THE INVENTION

1. Field of the Invention

The present invention relates generally to the field of multimedia content analysis and, more particularly, to a computer implemented method, system and computer program product for extracting salient keywords for videos.

2. Description of the Related Art

With recent advances in multimedia technology, the number of videos that are available to the general public, or to particular individuals or organizations, is growing rapidly. Efficient video search has thus become an important topic for both research and business. However, while videos contain a rich source of information including visual, aural and text information, text-based video search is currently the most effective search method and is preferred by most people. As a result, it has become increasingly important to-effectively index videos with appropriate text keywords so that the videos can be reliably searched and retrieved.

Assigning keywords to videos has conventionally been performed manually. FIG. 1 depicts a pictorial representation of a known manual keyword generation system for videos. The system is generally designated by reference number 100, and comprises human “expert” 102 at computer workstation 104 viewing video sequence 106 and manually annotating the video sequence using one or more keywords 108 which the expert believes well represents the content of the video sequence.

Although manual annotation of videos by human experts generally produces high-quality keywords for video search, the process is subjective, labor-intensive and very expensive.

As a result of recent advances in speech recognition and natural language processing technologies, systems are being developed for automatically extracting keywords from videos by using transcripts generated from speech contained in videos, or from text information, such as closed-captions, embedded in videos. Most of these systems however, simply treat all words equally or directly “transplant” keyword extraction techniques developed for pure text documents to the video domain without taking specific characteristics of videos into account.

Most current methods for selecting salient keywords in the traditional information retrieval (IR) field rely primarily on word frequency or other statistical information obtained from a collection of documents or from a single large document. These techniques however, do not work well for videos for at least two reasons: (1) most video transcripts are very short as compared to a typical text collection, and (2) it is unrealistic to assume that there exists a large collection of videos on one specific topic (as compared to collections of text materials). As a result, many “keywords” extracted from videos using these traditional techniques are not really content relevant; and video retrieval results returned based on these keywords are usually unsatisfactory.

There is, accordingly, a need for a mechanism for automatically extracting salient keywords for videos that can be used to index video content and to facilitate convenient yet accurate video browsing and retrieval.

### SUMMARY OF THE INVENTION

The present invention provides a computer implemented method, system and computer program product for extracting salient keywords for videos. A computer implemented method for extracting salient keywords for videos includes extracting a set of candidate keywords from a text source of a video, assigning a salience value to each candidate keyword based on statistical information to provide a set of statistically significant keywords, exploiting additional cues that are available to the video and that can be used to further measure the significance of existing keywords or to extract new keywords, and selecting a set of salient keywords for the video based on the set of statistically significant keywords and the additional cues.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a known manual keyword generation system for videos to assist in explaining aspects of the present invention;

FIG. 2 depicts a pictorial representation of a network of data processing systems in which aspects of the present invention may be implemented;

FIG. 3 is a block diagram of a data processing system in which aspects of the present invention may be implemented;

FIG. 4 is a block diagram that illustrates a salient keyword extraction system for videos according to an exemplary embodiment of the present invention;

FIG. 5 is a block diagram that illustrates details of the full text-based keyword extraction unit in the salient keyword extraction system of FIG. 4 according to an exemplary embodiment of the present invention;

FIG. 6 is a block diagram that illustrates details of the text-based discourse analysis unit in the salient keyword extraction system of FIG. 4 according to an exemplary embodiment of the present invention;

FIG. 7 is a block diagram that illustrates details of the audio/visual-based discourse analysis unit in the salient keyword extraction system of FIG. 4 according to an exemplary embodiment of the present invention;

FIG. 8 is a block diagram that illustrates details of the video text analysis unit in the salient keyword extraction system of FIG. 4 according to an exemplary embodiment of the present invention;

FIG. 9 is a block diagram that illustrates details of the text analysis of collateral materials unit in the salient keyword extraction system of FIG. 4 according to an exemplary embodiment of the present invention; and

FIG. 10 is a flowchart that illustrates a method for extracting salient keywords from videos according to an exemplary embodiment of the present invention.

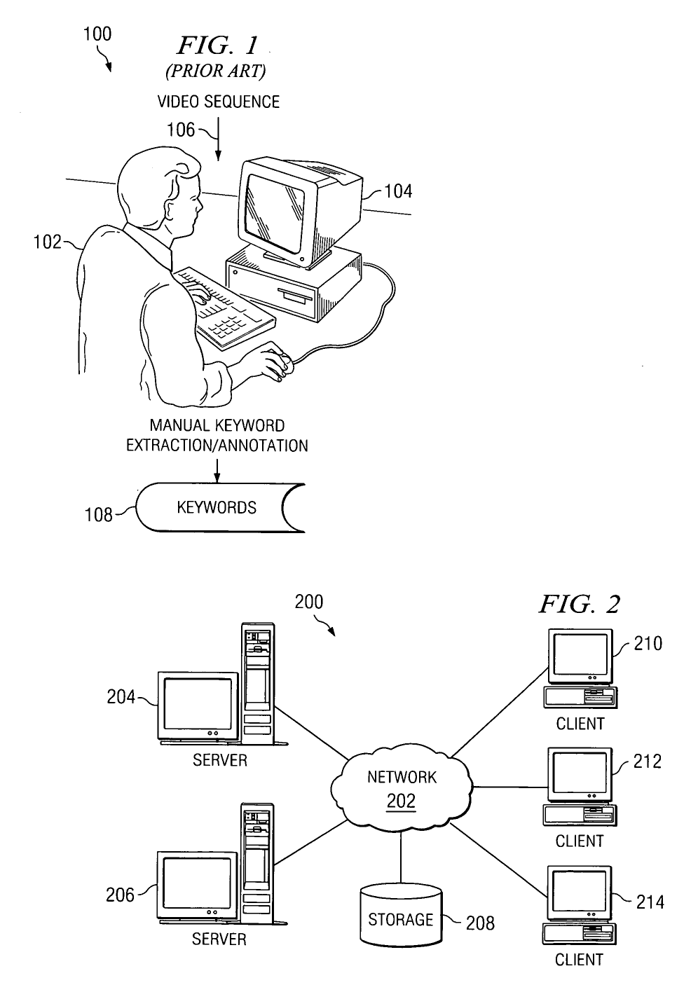

### DETAILED DESCRIPTION OF THE PREFERRED EMBODIMENT

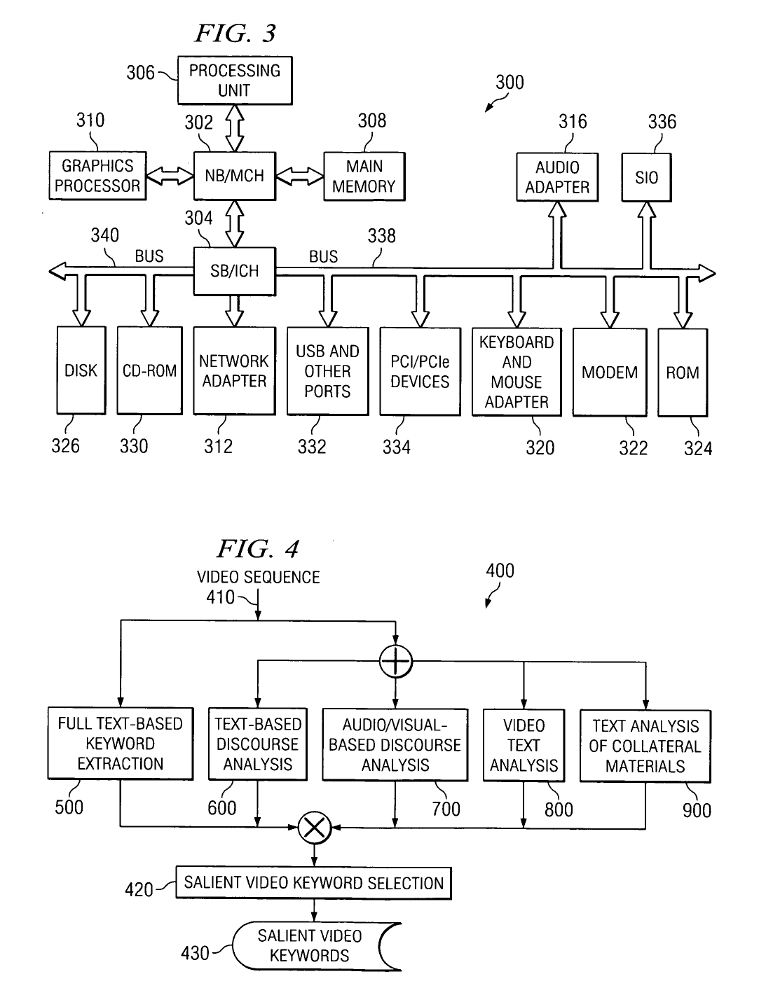

With reference now to the figures and in particular with reference to FIGS. 2-3, exemplary diagrams of data processing environments are provided in which embodiments of the present invention may be implemented. It should be appreciated that FIGS. 2-3 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 2 depicts a pictorial representation of a network of data processing systems in which aspects of the present invention may be implemented. Network data processing system 200 is a network of computers in which embodiments of the present invention may be implemented. Network data processing system 200 contains network 202, which is the medium used to provide communications links between various devices and computers connected together within network data processing system 200. Network 202 may include connections, such as wire, wireless communication links, or fiber optic cables.

In the depicted example, server 204 and server 206 connect to network 202 along with storage unit 208. In addition, clients 210, 212, and 214 connect to network 202. These clients 210, 212, and 214 may be, for example, personal computers or network computers. In the depicted example, server 204 provides data, such as boot files, operating system images, and applications to clients 210, 212, and 214. Clients 210, 212, and 214 are clients to server 204 in this example. Network data processing system 200 may include additional servers, clients, and other devices not shown.

In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for different embodiments of the present invention.

With reference now to FIG. 3, a block diagram of a data processing system is shown in which aspects of the present invention may be implemented. Data processing system 300 is an example of a computer, such as server 204 or client 210 in FIG. 2, in which computer usable code or instructions implementing the processes for embodiments of the present invention may be located.

In the depicted example, data processing system 300 employs a hub architecture including north bridge and memory controller hub (NB/MCH) 302 and south bridge and input/output (I/O) controller hub (SB/ICH) 304. Processing unit 306, main memory 308, and graphics processor 310 are connected to NB/MCH 302. Graphics processor 310 may be connected to NB/MCH 302 through an accelerated graphics port (AGP).

In the depicted example, local area network (LAN) adapter 312 connects to SB/ICH 304. Audio adapter 316, keyboard and mouse adapter 320, modem 322, read only memory (ROM) 324, hard disk drive (HDD) 326, CD-ROM drive 330, universal serial bus (USB) ports and other communication ports 332, and PCI/PCIe devices 334 connect to SB/ICH 304 through bus 338 and bus 340. PCI/PCIe devices may include, for example, Ethernet adapters, add-in cards, and PC cards for notebook computers. PCI uses a card bus controller, while PCIe does not. ROM 324 may be, for example, a flash binary input/output system (BIOS).

HDD 326 and CD-ROM drive 330 connect to SB/ICH 304 through bus 340. HDD 326 and CD-ROM drive 330 may use, for example, an integrated drive electronics (IDE) or serial advanced technology attachment (SATA) interface. Super I/O (SIO) device 336 may be connected to SB/ICH 304.

An operating system runs on processing unit 306 and coordinates and provides control of various components within data processing system 300 in FIG. 3. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 300 (Java is a trademark of Sun Microsystems, Inc. in the United States, other countries, or both).

As a server, data processing system 300 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 300 may be a symmetric multiprocessor (SMP) system including a plurality of processors in processing unit 306. Alternatively, a single processor system may be employed.

Instructions for the operating system, the object-oriented programming system, and applications or programs are located on storage devices, such as HDD 326, and may be loaded into main memory 308 for execution by processing unit 306. The processes for embodiments of the present invention are performed by processing unit 306 using computer usable program code, which may be located in a memory such as, for example, main memory 308, ROM 324, or in one or more peripheral devices 326 and 330.

Those of ordinary skill in the art will appreciate that the hardware in FIGS. 2-3 may vary depending on the implementation. Other internal hardware or peripheral devices, such as flash memory, equivalent non-volatile memory, or optical disk drives and the like, may be used in addition to or in place of the hardware depicted in FIGS. 2-3. Also, the processes of the present invention may be applied to a multiprocessor data processing system.

In some illustrative examples, data processing system 300 may be a personal digital assistant (PDA), which is configured with flash memory to provide non-volatile memory for storing operating system files and/or user-generated data.

A bus system may be comprised of one or more buses, such as bus 338 or bus 340 as shown in FIG. 3. Of course, the bus system may be implemented using any type of communication fabric or architecture that provides for a transfer of data between different components or devices attached to the fabric or architecture. A communication unit may include one or more devices used to transmit and receive data, such as modem 322 or network adapter 312 of FIG. 3. A memory may be, for example, main memory 308, ROM 324, or a cache such as found in NB/MCH 302 in FIG. 3. The depicted examples in FIGS. 2-3 and above-described examples are not meant to imply architectural limitations. For example, data processing system 300 also may be a tablet computer, laptop computer, or telephone device in addition to taking the form of a PDA.

The present invention provides a mechanism for extracting a better set of keywords, referred to herein as “salient keywords”, from videos by exploiting not only keyword statistics but also additional cues that are available to videos, including various sources of text, audio, visual and discourse knowledge. Although it should be understood that the present invention is not limited to extracting keywords from any particular type of video, exemplary embodiments described herein primarily target learning videos which convey educational information to audiences, such as training, lecture and seminar videos. In particular, with online learning or web-based e-learning rapidly emerging as a viable mechanism for offering customized and self-paced education to individuals, the number of learning videos that are available on corporate/academic institute intranets and on the Internet is dramatically increasing. Consequently, there is an urgent requirement to be able to effectively and efficiently search for desired videos from large collections of learning videos that are becoming available. In this context, exemplary embodiments of the present invention provide a computer implemented method, system and computer program product for automatically extracting salient text keywords for learning videos which takes various media cues including audio, visual and text information into account. The extracted keywords can then be used to index the video content and to facilitate convenient yet accurate video browsing, retrieval and categorization.

In general, by automatically annotating videos with topic-specific keywords, the present invention significantly reduces the cost and time for generating keywords for videos as compared to manual annotation. Moreover, by utilizing various sources of text, audio, visual and discourse knowledge, the present invention enhances the quality of generated keywords compared to prior automatic keyword extraction methods. Keywords extracted using the present invention greatly facilitates various video applications including browsing, searching and categorization.

FIG. 4 is a block diagram that illustrates a salient keyword extraction system for videos according to an exemplary embodiment of the present invention. The system is generally designated by reference number 400, and includes full text-based keyword extraction unit 500, and one or more of the following units: text-based discourse analysis unit 600, audio/visual-based discourse analysis unit 700, video text analysis unit 800, and text analysis of collateral materials unit 900.

As shown in FIG. 4, video sequence 410 is received by system 400, and is processed by unit 500 and one or more of units 600-900. The outputs of units 500-900 are input to salient video keyword selection unit 420 that selects and outputs a set of salient keywords 430 for video sequence 410.

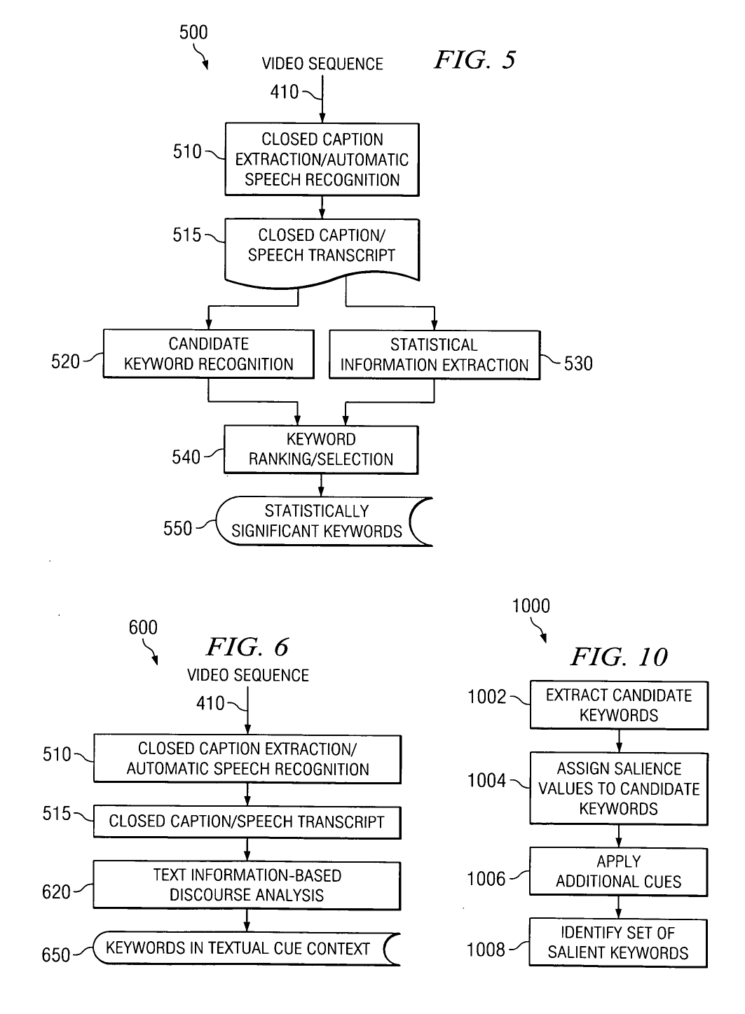

FIG. 5 is a block diagram that illustrates details of full text-based keyword extraction unit 500 in the salient keyword extraction system of FIG. 4 according to an exemplary embodiment of the present invention. Transcript 515 of video sequence 410 is created using a transcript generating mechanism 510. As shown in FIG. 5, transcript generating mechanism 510 may comprise a closed-caption extraction unit or, in case video sequence 410 does not contain closed-captions, an automatic speech recognition unit.

Candidate keyword recognition unit 520 identifies content-bearing words or phrases in the text of transcript 515 to provide a set of candidate keywords. Unit 520 preferably removes stop words before recognizing candidate keywords. A stop word is a commonly-used but content-irrelevant word such as articles (e.g., “the” and “a”), prepositions (e.g., “to”, “in” and “for”) and conjunctions (e.g., “and” and “but”).

Meanwhile, statistical information for each candidate keyword is extracted from transcript 515 by statistical information extraction unit 530. The statistical information may include, for example, information regarding word frequency in the text or the relative probability of the occurrence of words in the video against a general corpus.

The outputs of candidate keyword recognition unit 520 and statistical information extraction unit 530 are received by keyword ranking/selection unit 540. Keyword ranking/selection unit 540 ranks the candidate keywords output from candidate keyword recognition unit 520 based on the statistical information output by statistical information extraction unit 530, and selects a set of statistically significant keywords as shown at 550.

FIG. 6 is a block diagram that illustrates details of text-based discourse analysis unit 600 in the salient keyword extraction system of FIG. 4 according to an exemplary embodiment of the present invention. As shown in FIG. 6, discourse analysis unit 600 also processes text transcript 515 generated by transcript generating mechanism 510. Specifically, text-based discourse analysis unit 600 includes text information-based discourse analysis unit 620 that finds indicative sentences in transcript 515 where the topic(s) of video sequence 410 is likely mentioned and where salient keywords are more likely to be found. Examples of textual environments in the video sequence in which such indicative sentences may be found include:

1) the beginning part of the video sequence where the main topic of videos tend to be introduced;

2) the beginning sentences of each speaker who is engaged in a discussion in the video sequence and is thus likely to state the main points of his/her speech in the first few sentences;

3) during a group discussion, the host (or instructor)'s speech tends to contain more topic-specific information;

4) question sentences which usually contain important subject words; and

5) sentences that contain cue words or phrases such as “introduce”, “discuss”, “explain” and “this video is for . . . ”. Keywords appearing in these sentences are more likely related to content topics.

As shown in FIG. 6, the output of text information-based discourse analysis unit 620 is a set of keywords 650 in a textual cue context.

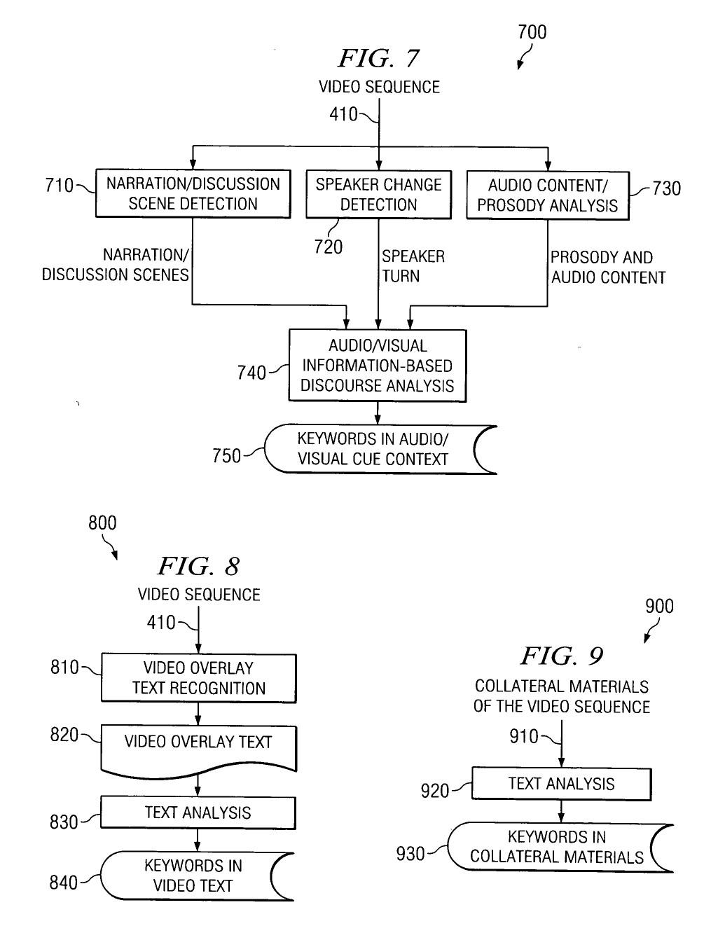

FIG. 7 is a block diagram that illustrates details of audio/visual-based discourse analysis unit 700 in the salient keyword extraction system of FIG. 4 according to an exemplary embodiment of the present invention. Audio/visual-based discourse analysis unit 700 analyzes embedded audio and visual information from video sequence 410 to locate cue points where content-specific keywords are more likely to appear. In particular, the audio/visual-based discourse analysis unit 700 includes several sub-units which analyze several aspects of video sequence 410. These sub-units include narration/discussion scene detection sub-unit 710, speaker change detection sub-unit 720, and audio content/prosody analysis sub-unit 730.

Narration/discussion scene detection sub-unit 710 locates segments of video sequence 410 where narration or discussion is going on. Specifically, a narration scene refers to a scene where an instructor or a host is giving a speech. In contrast, a discussion scene refers to a scene where an audience or students are engaged in a discussion. The speaker identification technique can also be applied here to identify the host or instructor. The identification of narration and discussion scenes provides the necessary information for the discourse analysis unit 620 as shown in FIG. 6.

Speaker change detection sub-unit 720 identifies boundaries where a change of speaker occurs. This information also helps cue the textual environment for the discourse analysis unit 620.

Audio content/prosody analysis sub-unit 730 recognizes words that are spoken with strong emphasis or with certain intonation, and also identifies special audio content types such as silence and music. It is observed that speech following a long pause or music moment tends to contain important information regarding the topics to be discussed. Also, words that are spoken with strong emphasis may be related to important content information.

The outputs of sub-units 710, 720 and 730 are input to audio/visual information-based discourse analysis unit 740 which outputs keywords in an audio/visual cue context as shown at 750.

FIG. 8 is a block diagram that illustrates details of video text analysis unit 800 in the salient keyword extraction system of FIG. 4 according to an exemplary embodiment of the present invention. Video text analysis unit 800 comprises video overlay text recognition unit 810 which recognizes video overlay text 820. Text analysis unit 830 then extracts keywords 840 from recognized video overlay texts 820 in video sequence 410. The video overlay text, such as those appearing in presentation slides (especially slide titles), information bulletins and speaker affiliation information, usually contains important information. As a result, keywords extracted from them tend to be more topic-specific.

FIG. 9 is a block diagram that illustrates details of text analysis of collateral materials unit 900 in the salient keyword extraction system of FIG. 4 according to an exemplary embodiment of the present invention. Text analysis of collateral materials unit 900 includes text analysis unit 920 which extracts keywords 930 from collateral materials 910 of video sequence 410. Such collateral materials could be, for example, a biography of a speaker in the video sequence, a calendar invite or an abstract of the speech when the video is a recorded talk. Collateral information can also include a course syllabus and handouts when the videos are recorded lectures; or training materials and manuals when the video is meant for a training purpose. Often, these collateral materials contain very rich and content-specific information regarding the video topics, and should be taken into account if they are available, when extracting salient keywords for a video.

Referring back to FIG. 4, and as indicated previously, the information extracted by each of units 500 to 900, are received by salient video keyword selection unit 420 which utilizes the extracted information to select and output a set of salient video keywords 430 for video sequence 410 which can be used for video searching, browsing, categorization and various other purposes.

In general, units 600-900 provide additional cues that may be available to video sequence 410 and that may be used with the statistically significant keywords output by full text-based keyword extraction unit 500 to effectively extract salient keywords for video sequence 410. It should be understood, however, that one or more of units 600-900 need not be utilized in all keyword extraction procedures. For example, some videos may not include useful collateral materials such that text analysis of collateral materials unit 900 is not needed to extract salient keywords for such videos.

FIG. 10 is a flowchart that illustrates a method for extracting salient keywords from videos according to an exemplary embodiment of the present invention. The method is generally designated by reference number 1000, and begins by extracting a set of candidate keywords from a text source of a video (Step 1002). This can be done, for example, by using closed caption extraction and/or automatic speech recognition. Each candidate keyword is then assigned a salience value based on statistical information to provide a set of statistically significant keywords (Step 1004). Statistical information may include, for example, word frequency in the text or the relative probability of the occurrence of words in the video against a general corpus.

Next, various additional cues that are available to the video are exploited to identify content-specific keywords (Step 1006). These cues can be obtained from various information sources such as discourse information, audio/visual cues and prosody, as well as from collateral materials that are related to the videos, if available. Finally, a set of salient keywords is identified for the video using the set of statistically significant keywords and the additional cues (Step 1008).

The present invention thus provides a computer implemented method, system and computer program product for extracting salient keywords for videos. A computer implemented method for extracting salient keywords for videos includes extracting a set of candidate keywords from a text source of a video. A salience value is assigned to each candidate keyword based on statistical information to provide a set of statistically significant keywords. Additional cues that are available to the video are exploited, and a set of salient keywords for the video is selected using the set of statistically significant keywords and the additional cues.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for extracting salient keywords for videos, the computer implemented method comprising:
extracting a set of candidate keywords from a text source of a video;
assigning a salience value to each candidate keyword based on statistical information to provide a set of statistically significant keywords;
exploiting additional cues that are available to the video; and
selecting a set of salient keywords for the video based on the set of statistically significant keywords and the additional cues.

2. The computer implemented method according to claim 1, wherein the text source comprises a transcript, and wherein extracting a set of candidate keywords from a text source of a video comprises:
extracting a set of candidate keywords from the transcript.

3. The computer implemented method according to claim 2, and further comprising generating the transcript from the video using one of closed-caption extraction, and automatic speech recognition.

4. The computer implemented method according to claim 1, wherein assigning a salience value to each candidate keyword based on statistical information to provide a set of statistically significant keywords comprises:
extracting a set of candidate keywords from the text source;
extracting statistical information regarding the set of candidate keywords from the text source; and
ranking the set of candidate keywords using the extracted statistical information to provide the set of statistically significant keywords.

5. The computer implemented method according to claim 1, wherein exploiting additional cues that are available to the video, comprises:
exploiting additional cues relating to at least one of:
indicative sentences in the text source where a topic of the video is more likely to be located,
embedded audio and visual information from the video for identifying locations in the video where content-specific keywords are likely to appear,
overlay text in the video, and
collateral materials related to the video.

6. The computer implemented method according to claim 5, wherein the indicative sentences comprise at least one of sentences at a beginning of the video, sentences at a beginning of a speech from a speaker engaged in a discussion in the video, sentences after a long silence or music break, sentences from major characters in the video, question sentences and sentences that contain cue words.

7. The computer implemented method according to claim 5, wherein the embedded audio and visual information comprises at least one of:
information relating to narration and discussions in the video;
information relating to a boundary where there is a change of speaker; and
information relating to words spoken with emphasis or intonation, or relating to a period of music or silence in the video.

8. The computer implemented method according to claim 5, wherein the overlay text comprises text appearing in one or more types of video frames that contain presentation slides, information bulletins and speaker affiliation information.

9. The computer implemented method according to claim 5, wherein the collateral materials related to the video comprises at least one of a biography of a speaker, a calendar invite note, a speech abstract, a course syllabus and handout materials.

10. The computer implemented method according to claim 1, wherein the video comprises a learning video.

11. A system for extracting salient keywords for videos, comprising:
a full text-based keyword extraction unit for extracting a set of candidate keywords from a text source of a video, and for assigning a salience value to each candidate keyword based on statistical information to provide a set of statistically significant keywords;
additional information extraction units for exploiting additional cues that are available to the video; and
a salient keyword selection unit for selecting a set of salient keywords for the video based on the set of statistically significant keywords and the additional cues.

12. The system according to claim 11, wherein the text source comprises a transcript, and wherein the system further includes one of a closed-caption extraction unit and an automatic speech recognition unit for generating the transcript.

13. The system according to claim 11, wherein the additional information extraction units comprise at least one of:
a text-based discourse analysis unit for extracting indicative sentences in the text source where a topic of the video is more likely to be located;
an audio/visual-based discourse unit for extracting embedded audio and visual information from the video for identifying locations in the video where content-specific keywords are likely to appear;
a video text analysis unit for analyzing overlay text in the video; and
a text analysis of collateral materials unit for analyzing collateral materials related to the video.

14. The system according to claim 13, wherein the audio/visual-based discourse unit comprises at least one of a narration/discussion scene detection sub-unit, a speaker change detection sub-unit and an audio content/prosody analysis sub-unit.

15. The system according to claim 13, wherein the collateral materials comprises at least one of a biography of a speaker, a calendar invite note, a speech abstract, course syllabus and handout materials.

16. A computer program product, comprising:
a computer usable medium having computer usable program code for extracting salient keywords for videos, the computer program product comprising:
computer usable program code configured for extracting a set of candidate keywords from a text source of a video;
computer usable program code configured for assigning a salience value to each candidate keyword based on statistical information to provide a set of statistically significant keywords;
computer usable program code configured for exploiting additional cues that are available to the video; and
computer usable program code configured for selecting a set of salient keywords for the video based on the set of statistically significant keywords and the additional cues.

17. The computer program product according to claim 16, wherein the text source comprises a transcript, and wherein the computer usable program code configured for extracting a set of candidate keywords from a text source of a video comprises:
computer usable program code configured for extracting a set of candidate keywords from the transcript using one of closed-caption extraction, and automatic speech recognition.

18. The computer program product according to claim 16, wherein the computer usable program code configured for assigning a salience value to each candidate keyword based on statistical information to provide a set of statistically significant keywords comprises:
computer usable program code configured for extracting a set of candidate keywords from the text source;
computer usable program code configured for extracting statistical information regarding the set of candidate keywords from the text source; and
computer usable program code configured for ranking the set of candidate keywords using the extracted statistical information to provide the set of statistically significant keywords.

19. The computer program product according to claim 16, wherein the computer usable program code configured for exploiting additional cues that are available to the video, comprises:
computer usable program code configured for exploiting additional cues relating to at least one of:
indicative sentences in the text source where a topic of the video is more likely to be located,
embedded audio and visual information from the video for identifying locations in the video where content-specific keywords are likely to appear,
overlay text in the video, and
collateral materials related to the video.

20. The computer program product according to claim 19, wherein the computer usable program code configured for extracting embedded audio and visual information comprises:
computer usable program code configured for extracting at least one of information relating to narration and discussions in the video, information relating to a boundary where there is a change of speaker, information relating to words spoken with emphasis or intonation, and information relating to a period of music or silence in the video
